(19) United States
(12) Patent Application Publication
(10) Pub. No.: US 2026/0118938 A1
(43) Pub. Date: Apr. 30, 2026

(54) POWER BUDGETING FOR DATA PROCESSING SYSTEMS USING POWER-BASED COMMUNICATIONS

(71) Applicant: Dell Products L.P., Round Rock, TX (US)

(72) Inventors: CHRISTOPHER BAUER ATKINSON, Woodstock, GA (US); KIRK FREY, Flemington, NJ (US); ETHAN A. KALEY, North Kingstown, RI (US)

(21) Appl. No.: 18/931,565

(22) Filed: Oct. 30, 2024

(51) Int. Cl. G06F 1/3203; G06F 1/28

(52) U.S. Cl. CPC G06F 1/3203; G06F 1/28

(57) ABSTRACT

Methods and systems for managing a data processing system are disclosed. A power distribution unit (PDU) may supply power to the data processing system via a multi-function connection adapted to facilitate communication between the data processing system and the PDU. Based on an identification of an occurrence of a power budgeting event for the data processing system, the data processing system may use the multi-function connection to provide a power cap request to the PDU, and to obtain a response to the power cap request from the PDU. The response may be based on a mapping of a power distribution system that includes the PDU, and the response may indicate a new power state for the data processing system. The data processing system may enforce the power state on at least hardware resources of the data processing system in order to provide computer-implemented services.

### FIELD

Embodiments disclosed herein relate generally to managing data processing systems. More particularly, embodiments disclosed herein relate to systems and methods for managing power budgeting for the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a distributed system in accordance with an embodiment.

FIG. 1B shows a block diagram illustrating a data processing system in accordance with an embodiment.

FIG. 1C shows a block diagram illustrating an example of a power distribution system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing a data processing system. The data processing system may belong to a deployment of data processing systems that provide computer-implemented services to downstream consumers. The deployment may include a power distribution system that powers the data processing systems. The power distribution system may convert large scale power input (e.g., from a utility power grid) to small scale power (e.g., usable by a data processing system), and may distribute the converted power to the data processing systems. The power distribution system may include components such as power distribution units (PDUs), power panels, transfer switches, back-up generators, batteries, etc., that participate in distributing power to the data processing systems.

Each PDU of the power distribution system may provide power to one or more data processing systems connected to each of the PDUs via distinct power connections. Each PDU may be capable of supplying a limited amount of power to power-connected data processing systems in a period of time (e.g., based on power rating for the PDUs). To meet objectives for power distribution within the deployment (e.g., power consumption by the data processing systems), limited power resources may be allocated across the deployment based on a power budget. For example, the power budget may specify power caps for components of the deployment (e.g., data processing systems, PDUs) in order to regulate power consumed by and/or power supplied to each of the data processing systems.

A management system may be tasked with managing power budgeting for the deployment. To do so, the management system may rely on information such as power information for components of the deployment (e.g., power information for the data processing systems, the PDUs). For example, the power information may include identifiers for the components of the deployment, power ratings of the components, and/or information regarding power supply and demand between the components over time. The power information may be used to obtain a mapping of the power distribution system. The mapping of the power distribution system may include information regarding power connections between components of the deployment, and other power-related information usable to determine power caps for the components and/or to otherwise manage power budgeting for the deployment.

However, power consumption requirements may differ among the data processing systems of the deployment, and power consumption requirements for each data processing system may vary over time; therefore, static power caps may be unlikely to optimize power distribution within the deployment over time. In addition, due to a complex and dynamic architecture of the power distribution system, some manual and/or automated methods for obtaining power information for the deployment may be tedious, resource intensive, and/or may disrupt the provisioning of the computer-implemented services. For example, manual efforts to obtain the power information may be subject to human error, and automated efforts may interrupt critical processes and/or may not provide sufficiently detailed information (e.g., at the PDU power port level). As a result, the information may be unreliable (e.g., erroneous, lacking detail, out of date) for use in power budgeting and/or regulating dynamic power caps.

Thus, to improve power budgeting for the deployment, power connections between components of the deployment (e.g., between the data processing systems and the PDUs) may include multi-function connections adapted to both supply power to the data processing systems from the PDUs, and facilitate communication between the data processing systems and the PDUs. Using the multi-function connections, (near) real-time power information may be exchanged between the data processing systems and the PDUs and/or may be provided to the management system for power budgeting purposes. For example, the management system may use the power information to obtain a reliable (e.g., detailed, up to date) mapping of the power distribution system suitable for regulating dynamic power caps in accordance with objectives for power distribution within the deployment.

By doing so, power budgeting for the deployment may be managed using power-based communications over existing multi-function (e.g., power) connections, without requiring additional types of connections between the data processing systems and the PDUs. As a result, objectives for power distribution within the deployment may be more likely to be met, and the deployment may be more likely to provide desired (e.g., reliable, uninterrupted and/or otherwise expected) computer-implemented services.

In an embodiment, a method for managing a data processing system is provided. The method may include making an identification, by the data processing system, of an occurrence of a power budgeting event for the data processing system, and, based on the identification: providing, by the data processing system and using a multi-function connection, a power cap request for the data processing system to a PDU that supplies power to at least the data processing system, and the multi-function connection being adapted to both supply power to the data processing system and facilitate communication between the data processing system and the PDU; obtaining, by the data processing system, a response to the power cap request via the multi-function connection and from the PDU, the response being based on a mapping of a power distribution system maintained by a management system, the mapping being based on power information provided by the data processing system and the PDU using the multi-function connection, and the response indicating a new power state for the data processing system; enforcing, by the data processing system, the new power state on at least hardware resources of the data processing system to obtain an updated data processing system; and, providing, using the updated data processing system, computer-implemented services.

The power cap request may include at least one selected from a group consisting of: an identifier for the data processing system; a rating for a power source of the data processing system; and, information regarding power consumption by the power source over time.

The management system may be tasked with managing power budgeting for a deployment of data processing systems that includes the data processing system.

The mapping of the power distribution system may be based on at least one selected from a group consisting of: power connections between components of the deployment; existing power caps for the components of the deployment; workloads performed by the data processing systems; and, priority levels for the data processing systems and/or the workloads.

The response may be based, at least in part, on the mapping of the power distribution system, and an objective for power distribution within the deployment. The response may also be based, at least in part, on a power cap for the PDU. The power cap for the PDU may be based, at least in part, on power caps for other PDUs of the deployment. The response may include a power cap for the data processing system based, at least in part, on a priority level for the data processing system.

Enforcing the new power state may modify power consumption by the data processing system in accordance with the priority level.

The providing and obtaining may be performed while power is being distributed via the multi-function connection.

The PDU may be connected to at least two data processing systems via distinct multi-function connections. The PDU may be adapted to obtain data center level power and supply power source level power via distinct multi-function connections.

The data processing system may be connected to the PDU via an out-of-band communication channel that runs through a network module of the data processing system, and the out-of-band communication channel may service a management controller of the data processing system.

The data processing system may be connected to at least one other entity via an in-band communication channel that also runs through the network module, and the in-band communication channel may service the hardware resources.

A non-transitory media may include computer instructions that when executed by a processor cause the computer-implemented method to be performed.

The data processing system may include the non-transitory media and a processor, and may perform the computer-implemented method when the computer instructions are executed by the processor.

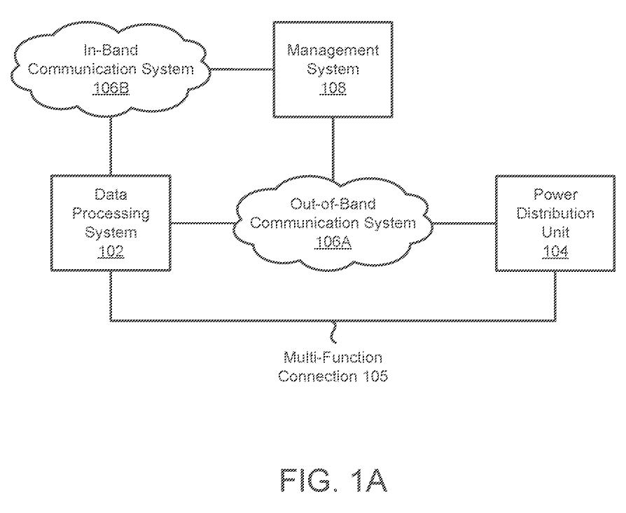

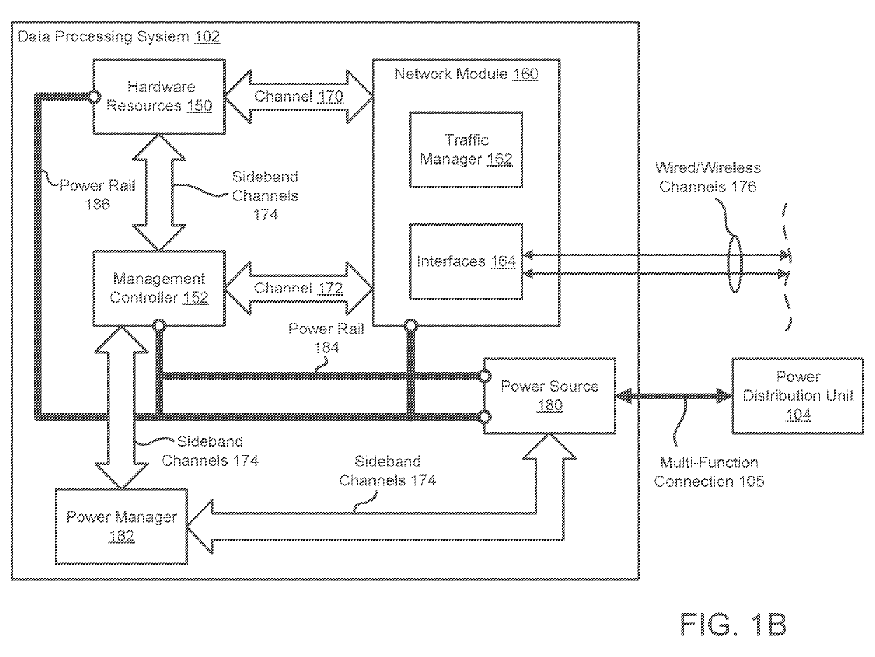

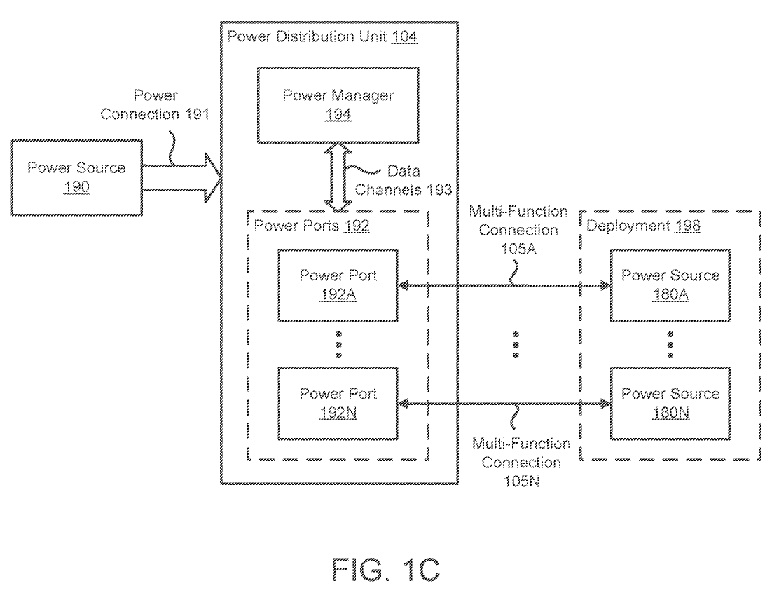

Turning to FIG. 1A, a block diagram illustrating a distributed system in accordance with an embodiment is shown. The system shown in FIG. 1A may provide computer-implemented services. The computer-implemented services may include any type and quantity of computer-implemented services. For example, the computer-implemented services may include communication services, data storage services, database services, data generation services, and/or any other type of service that may be implemented with a computing device.

To provide the computer-implemented services, the distributed system may include any number of data processing systems of a deployment. Each data processing system may include hardware resources (e.g., hardware and/or software components) and may independently and/or in some combination with the other data processing systems, provide a portion of the computer-implemented services. The data processing systems may each include a power source that provides power to the hardware resources, and each power source may obtain power through a power connection to a power distribution system of the deployment.

The power distribution system may include various components for obtaining large scale power such as data center level power, and supplying small scale power, such as power source level power usable by the power sources of the data processing systems via the power connections. For example, the power distribution system may include power panels, transfer switches, back-up generators, batteries, power distribution units (PDUs), and/or other components that participate in distributing power (e.g., converting power and/or otherwise managing the supply of power) to the each of the power sources.

To provide power to the data processing systems, at least a portion of the PDUs of the power distribution system may be connected to the data processing systems via distinct power connections. The architecture of the power distribution system may be complex. For example, multiple PDUs of the power distribution system may each provide power to multiple data processing systems via distinct power connections. As data processing systems are added to or removed from the deployment, and/or for other reasons, the power connections may be modified, resulting in changes to the architecture of the power distribution system over time.

Power consumption requirements among different data processing systems of the deployment may vary, and the power consumption requirements of each data processing system may vary over time. For example, different types of workloads (e.g., heavy workloads, light workloads) may require different quantities of power over different periods of time, and the workloads may be distributed among the data processing systems based on a variety of potentially contradictory factors (e.g., hardware resource requirements for each workload, hardware resource availability over time, and/or time factors). Therefore, if power consumption by the data processing systems is not managed (e.g., regulated) appropriately, then some PDUs may become overloaded with power demands, while power supplied by other PDUs may go unused. This may result in inefficient use of limited power resources and/or interruptions to the computer-implemented services.

Therefore, to manage power consumption by the data processing systems over time, the limited power resources may be allocated to data processing systems of the deployment based on a power budget for the deployment. For example, power budgeting may be performed to determine power consumption requirements and allowances for each data processing system of the deployment, constrained by in capabilities of each PDU of the power distribution system and by objectives for power distribution within the deployment over time.

To manage power distribution within the deployment, power caps for components of the deployment may be established. The power caps may define a maximum magnitude of power per unit time (e.g., in Watts) that may be consumed by each of the components. For example, data processing systems that perform heavier workloads that require more power may be assigned higher power caps than data processing systems that perform lighter workloads that require less power. Likewise, higher power caps may be assigned to PDUs that provide power to heavier workload data processing systems than PDUs that provide power to lighter workload data processing systems.

The power caps for the components of the deployment may be dependent on one another (e.g., due to limited availability of power resources and/or due to the architecture of the power distribution system). Therefore, establishing the power caps through power budgeting may require analysis of reliable (e.g., detailed, up to date) information regarding the deployment. For example, the analysis may be based on a mapping of the power distribution system (e.g., power connections between components of the deployment) and information regarding consumption and supply of power for the deployment. Due to the complex, dynamic architecture of the power distribution system and variations in power consumption across the deployment over time, frequent updates to the information may be required to ensure its reliability.

However, manual efforts to update the information used for power budgeting may be resource intensive and/or may be subject to human error (e.g., manual reporting of power connections and power consumption information), and automated methods for mapping the power connections (e.g., rolling outages, intentional power modulation) may interrupt critical processes and/or may not provide sufficiently detailed information (e.g., to map power connections at the power port level), which may result in unreliable information for power budgeting.

Enforcing the power caps on each data processing system of the deployment may also require resource intensive and/or error-prone manual efforts. For example, the power caps may be enforced by manually modifying hardware and/or software components of the data processing systems (e.g., setting limits on power draw of a power source of each data processing system of the deployment). Therefore, manual efforts may not be feasible to enforce the power caps for large deployments, especially when the power caps are modified frequently over time (e.g., dynamic power caps).

In general, embodiments disclosed herein may provide methods, systems, and/or devices for managing power budgeting for data processing systems using power-based communications. To do so, connections used to power the data processing systems may include multi-function connections that both supply power to the data processing systems via the PDUs and facilitate communication between the data processing systems and the PDUs. While power is being distributed via the multi-function connections, the data processing systems and the PDUs may use the multi-function connections to provide power information usable for power budgeting.

The power information may include information usable to identify power connections between the data processing systems and distinct power ports of the PDUs, and to measure power supply and demand at the power port level over time. Using the power information, a management system tasked with power budgeting for the deployment may obtain and maintain a reliable mapping of the power distribution system that indicates real-time and/or predicted power supply and demand across the deployment. The mapping of the power distribution system may be used to determine power caps (e.g., dynamic power caps that reflect the dynamic nature of power consumption across the deployment), and the power caps may be automatically enforced on the data processing systems via data transmission over the multi-function connections.

By doing so, power budgeting for the deployment may be facilitated using power-based communications over existing power connections between components of the deployment, reducing the need for manual efforts and/or additional data connections. Accordingly, limited power resources may be more likely to be distributed within the deployment in accordance with objectives, and the deployment may be more likely to provide desired (e.g., reliable, uninterrupted and/or otherwise expected) computer-implemented services.

To provide the above-mentioned functionality, the distributed system of FIG. 1A may include data processing system 102, power distribution unit 104, management system 108, and any number of communication systems (e.g., out-of-band communication system 106A, in-band communication system 106B). The distributed system, any components thereof, and/or any other types of devices or components not shown in FIG. 1A may perform all, or a portion of the computer-implemented services independently and/or cooperatively. Each of these components is discussed below.

Data processing system 102 may include any number of data processing systems. For example, data processing system 102 may include a single data processing system (e.g., powered via a power port of a PDU of the power distribution system), a group of data processing systems (e.g., powered via a PDU of the power distribution system), and/or a deployment of data processing systems (e.g., groups of data processing systems powered via multiple PDUs of the power distribution system). Data processing system 102 may provide computer-implemented services while hardware resources of data processing system 102 are operational (e.g., powered).

In the example shown in FIG. 1A, data processing system 102 may be connected to power distribution unit 104, and power may be provided to data processing system 102 from power distribution unit 104 via multi-function connection 105. Data processing system 102 may include functionality for transmitting and/or receiving data over multi-function connection 105 using power-line communication technology.

Multi-function connection 105 may include a power connection adapted to both (i) supply power to data processing system 102, and (ii) facilitate at least one-way communication between connected entities (e.g., data processing system 102 and power distribution unit 104). For example, multi-function connection 105 may be facilitated by a power cable plugged into a power receptacle of data processing system 102 and into a power receptacle (e.g. a power port) of power distribution unit 104.

To manage power consumption by the hardware resources of data processing system 102, data processing system 102 may identify occurrences of power budgeting events for data processing system 102. The occurrences of the power budgeting events may indicate a change in power consumption requirements for the hardware resources and/or a change in power supplied to the hardware resources over periods of time. For example, based on identified occurrences of power budgeting events, data processing system 102 may (i) obtain power cap requests for data processing system 102, (ii) provide the power cap requests to other entities, (iii) obtain responses to the power cap requests from the other entities, (iv) enforce new power states indicated by the responses on at least the hardware resources, and/or (v) perform other actions. For example, data processing system 102 may provide power cap requests to and/or obtain responses from power distribution unit 104 over multi-function connection 105.

To enforce the new power state on the hardware resources and/or to otherwise manage the operation of the hardware resources, data processing system 102 may include out-of-band components. The out-of-band components may include functionality for managing operation of the hardware resources and/or communicating with other devices using out-of-band methods (e.g., exchanging data with the other devices using out-of-band communication channels that circumvent in-band communication channels servicing the hardware resources). Refer to the discussion of FIG. 1B for more information regarding components of data processing system 102.

Power distribution unit 104 may include at least one of any number of PDUs of the power distribution system that distributes power to data processing system 102. Power distribution unit 104 may include any type of PDU, such as a basic PDU, a smart metered PDU, a switched PDU, an intelligent rack PDU, etc., and may include any number and/or type of power ports (e.g., power receptacles). Power distribution unit 104 may supply power to data processing system 102 and to other data processing systems of the deployment. For example, power distribution unit 104 may supply power to data processing system 102 via multi-function connection 105, and to the other data processing systems via distinct multi-function connections similar to multi-function connection 105. Power distribution unit 104 may include functionality for transmitting and/or receiving data over multi-function connection 105 using power-line communication technology. Refer to the discussion of FIG. 1C for more information regarding power distribution to data processing system 102.

To participate in power budgeting for the deployment, power distribution unit 104 and data processing system 102 may exchange power information via multi-function connection 105. For example, data processing system 102 may transmit power information for data processing system 102 to power distribution unit 104 and/or power distribution unit 104 may transmit power information for power distribution unit 104 to data processing system 102.

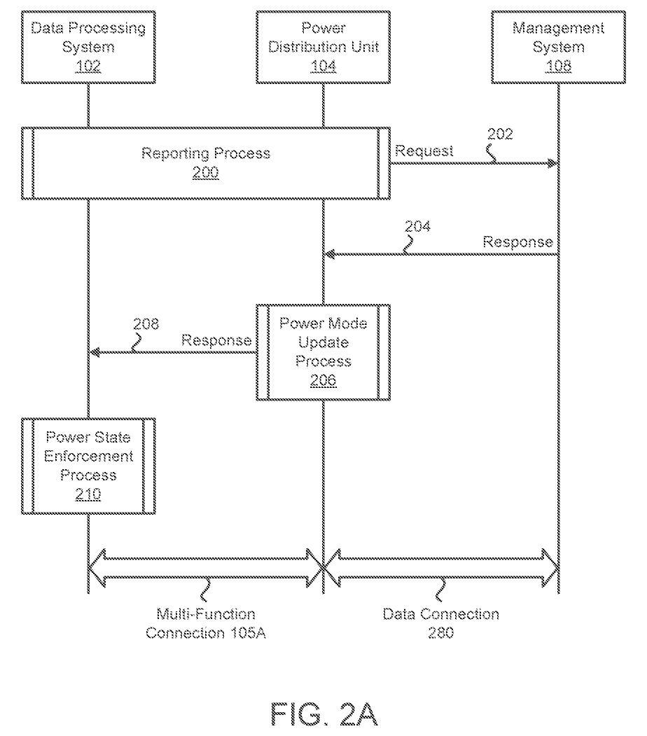

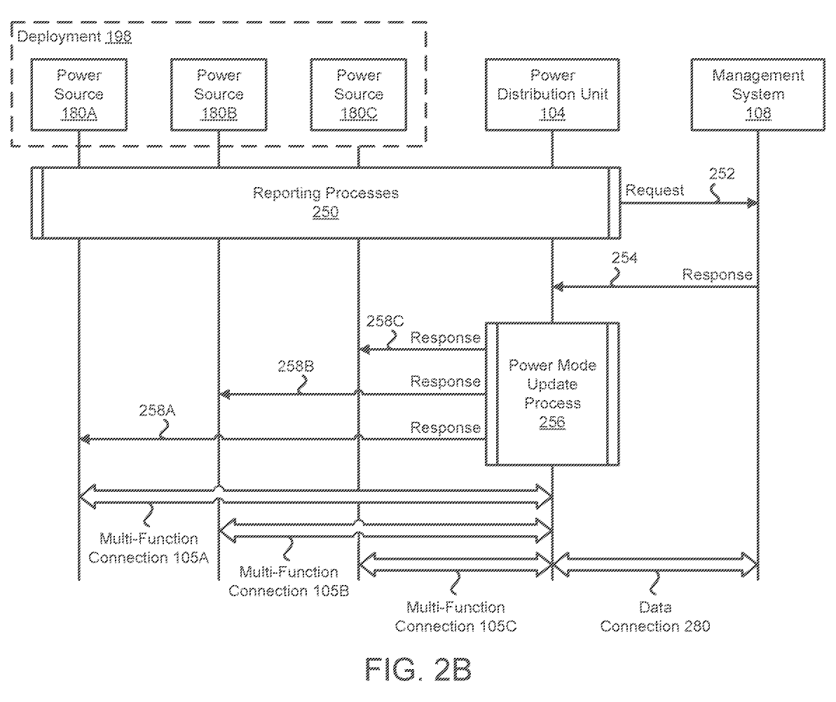

Power distribution unit 104 may communicate with other entities regarding power distribution to and/or power consumption by data processing system 102. For example, power distribution unit 104 may provide information usable for power budgeting to management system 108 (e.g., power information, power cap requests) and/or may obtain responses regarding power budgeting for data processing system 102 (and/or other connected data processing systems) from management system 108. Power distribution unit 104 may communicate with management system 108, for example, via a data connection. The data connection may include any type of connection usable for transmitting and/or receiving data over any type of communication system (e.g., shown as data connection 280 in FIGS. 2A-2B).

Management system 108 may include any number of systems that provide various services for managing the deployment including data processing system 102, such as power budgeting services, power distribution services, workload assignment services, etc. For example, management system 108 may maintain (e.g., generate, update) a mapping of the power distribution system based on power information provided by data processing system 102 and power distribution unit 104. The mapping of the power distribution system may be used to establish power caps for the deployment. Refer to the discussion of FIG. 1C for more information regarding power distribution system mappings.

Management system 108 may manage power budgeting for the deployment by (i) obtaining power information for components of the deployment, (ii) updating the mapping of the power distribution system based on the power information, (iii) obtaining power cap requests for the components, (iv) obtaining responses to the power cap requests based on the mapping of the power distribution system, and/or (v) providing the responses to the components. For example, management system 108 may manage power budgeting for data processing system 102 via power distribution unit 104.

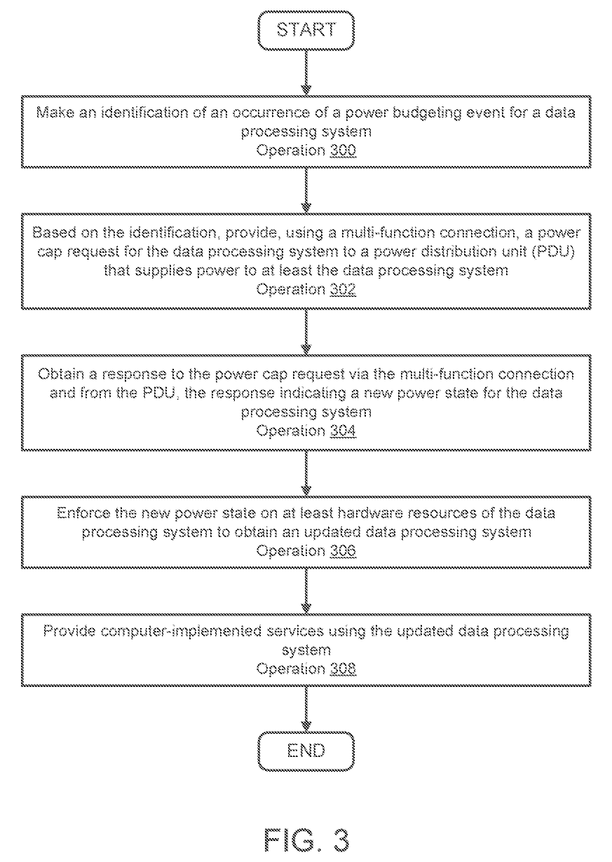

When providing their functionality, any of data processing system 102, power distribution unit 104, management system 108, and/or components thereof may perform all, or a portion of the actions and methods illustrated in FIGS. 2A-3.

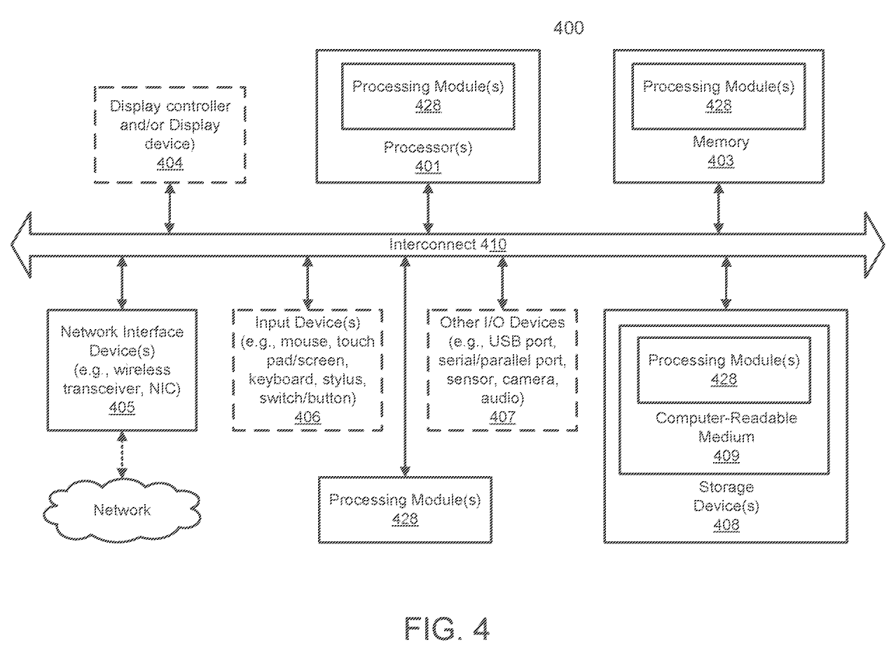

Any of data processing system 102, power distribution unit 104, and management system 108 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1A may be operably connected to each other (and/or components not illustrated) with a communication system. The communication system may facilitate communications between the components of FIG. 1A. In an embodiment, the communication system includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

For example, the communication system may include out-of-band communication system 106A and in-band communication system 106B. Out-of-band communication system 106A may facilitate communication between the out-of-band components of data processing system 102, power distribution unit 104, management system 108, and/or other devices connected to out-of-band communication system 106A; whereas in-band communication system 106B may facilitate communication between in-band components of data processing system 102, management system 108, and other entities (e.g., devices) connected to in-band communication system 106B.

While illustrated separately in FIG. 1A, out-of-band communication system 106A and in-band communication system 106B may be the same communication system. Although not shown in FIG. 1A, power distribution unit 104 may be connected to in-band communication system 106B.

While illustrated in FIG. 1A as including a limited number of specific components, a system in accordance with an embodiment may include fewer, additional, and/or different components than those illustrated therein.

Turning to FIG. 1B, a diagram illustrating a data processing system in accordance with an embodiment is shown. Data processing system 102 shown in FIG. 1B may be similar to any of the computing devices shown in FIG. 1A.

To provide computer-implemented services, data processing system 102 may include any quantity of hardware resources 150. Hardware resources 150 may be in-band (hardware) components, and may include a processor operably coupled to memory, storage, and/or other hardware components.

The processor may host various management entities such as operating systems, drivers, network stacks, and/or other software entities that provide various management functionalities. For example, the operating system and drivers may provide abstracted access to various hardware resources. Likewise, the network stack may facilitate packaging, transmission, routing, and/or other functions with respect to exchanging data with other devices.

For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, then these entities may subsequently compromise the operation of the applications. For example, if various drivers and/or the communication stack are compromised, then communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 102) to another device via any number of intermediate networks (e.g., via wired/wireless channels 176 that are part of the networks).

To reduce the likelihood of the applications and/or other in-band entities from being indirectly compromised, data processing system 102 may include management controller 152 and network module 160. Each of these components of data processing system 102 is discussed below.

Management controller 152 may be implemented, for example, using a system on a chip or other type of independently operating computing device (e.g., independent from the in-band components, such as hardware resources 150 of a host data processing system 102). Management controller 152 may provide various management functionalities for data processing system 102. Management controller 152 may, for example, monitor various ongoing processes performed by the in-band components, may manage power distribution, thermal management, and/or may perform other functions for managing data processing system 102.

To do so, management controller 152 may be operably connected to various components via sideband channels 174 (in FIG. 1B, a limited number of sideband channels are included for illustrative purposes, it will be appreciated that management controller 152 may communicate with other components via any number of sideband channels). The sideband channels may be implemented using separate physical channels, and/or with a logical channel overlay over existing physical channels (e.g., logical division of in-band channels).

The sideband channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, when managing power consumption by hardware resources 150, management controller 152 may use sideband channels 174 to initiate and/or perform, at least in part (e.g., in cooperation with hardware resources 150), actions for enforcing a new power state on hardware resources 150.

To reduce the likelihood of indirect compromise of an application hosted by hardware resources 150, management controller 152 may, for example, enable information from other devices to be provided to the application without traversing the network stack and/or management entities of hardware resources 150. To do so, the other devices may direct communications including the information to management controller 152.

Management controller 152 may then, for example, send the information via sideband channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similarly, processes may be used to facilitate outbound communications from the applications.

Management controller 152 may be operably connected to communication components of data processing system 102 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted components may not result in indirect compromise of any management controller 152, and entities hosted by management controller 152.

To facilitate communication with other devices, data processing system 102 may include network module 160. Network module 160 may provide communication services for in-band components and out-of-band components (e.g., management controller 152) of data processing system 102. To do so, network module 160 may include traffic manager 162, and interfaces 164.

Traffic manager 162 may include functionality to (i) discriminate traffic directed to various network endpoints advertised by data processing system 102, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wireless wide area network (WWAN) card, a Wi-Fi card, a wireless local area network card, a wired local area network card, an optical communication card, and/or other types of communication components. These components may support any number of wired/wireless channels 176.

Thus, from the perspective of an external device, the in-band components and out-of-band components of data processing system 102 may appear to be two independent network entities that may be independently addressable and/or otherwise unrelated to one another.

To power hardware resources 150 and/or other components of data processing system 102, data processing system 102 may include power source 180. Power source 180 may include any type of power source (e.g., a power supply, a battery, etc.) and may distribute power to hardware resources 150 and/or the other components (e.g., management controller 152) via power rails 186 and/or 184. Power source 180 may provide an amount of power consistent with ratings for power source 180 (e.g., maximum power output, efficiency). Power source 180 may obtain a supply of power from a PDU (e.g., power distribution unit 104) via a multi-function connection (e.g., multi-function connection 105, multi-function connections 105A-105N shown in FIG. 1C and in FIGS. 2A-2B.). For example, multi-function connection 105 may be connected to a power receptacle of power source 180 and a power receptable (e.g., a power port) of power distribution unit 104.

Power source 180 may include components for obtaining power and/or data (e.g., power information) from power distribution unit 104. For example, power source 180 may include components adapted to filter data signal from power signal. Power source 180 may include components for providing data (e.g., power information) to power distribution unit 104. For example, power source 180 may include a component adapted to encode data onto a carrier signal distributed via multi-function connection 105 to facilitate communications with power distribution unit 104. The data may include power information such as an identifier for power source 180, a rating for power source 180, and/or other power information received from other components of data processing system 102, such as power manager 182.

To manage power distribution to hardware resources 150, data processing system 102 may include power manager 182. Power manager 182 may manage power distribution to hardware resources 150 from power source 180 (e.g., supplied via power rail 184 and/or power rail 186). To do so, power manager 182 may communicate with power source 180 and/or management controller 152 via sideband channels 174. Power manager 182 may participate in (i) identifying occurrences of power budgeting events for data processing system 102, (ii) obtaining (e.g., generating) power cap requests for data processing system 102, and/or (iii) other actions for managing (e.g., regulating) power consumption by hardware resources 150.

For example, power manager 182 may (i) communicate with management controller 152 regarding power states of hardware resources 150, (ii) monitor power consumption by hardware resources 150, and/or (iii) report changes in power consumption by power source 180 over time to management controller 152 and/or to other components.

To facilitate management of data processing system 102 over time, hardware resources 150, management controller 152 and/or network module 160 may be positioned in separately controllable power domains. By being positioned in these separate power domains, different subsets of these components may remain powered while other subsets are unpowered.

For example, management controller 152 and network module 160 may remain powered while hardware resources 150 are unpowered. Consequently, management controller 152 may remain able to communicate with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, power source 180 may separately supply power to the power rails (e.g., power rail 184, power rail 186) that power the respective power domains. Power from the power source 180 may be selectively provided to the separate power rails to selectively power the different power domains. Management controller 152 may cooperate with power manager 182 to manage supply of power to these power domains. Management controller 152 may communicate with power manager 182 via sideband channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

Turning to FIG. 1C, a diagram illustrating a power distribution system in accordance with an embodiment is shown. Power distribution unit 104 shown in FIG. 1C may be similar to any of the computing devices shown in FIG. 1A. The power distribution system may include power source 190, power distribution unit 104, and/or other components (not shown).

The power distribution system may distribute power to a deployment of data processing systems, such as deployment 198. Deployment 198 may include any number of data processing systems (e.g., similar to data processing system 102). For example, deployment 198 may be subdivided into groups (e.g., racks) of data processing systems for powering purposes. In FIG. 1C, a group of data processing systems is shown to include power sources 180A-180N. Power sources 180A-180N may be powered via power distribution unit 104 (e.g., a rack PDU).

Power distribution unit 104 may include any PDU of the power distribution system. Power distribution unit 104 may include any number of power ports 192 (e.g., 192A-192N) by which power is provided to power sources (e.g., 180A-180N) via distinct multi-function connections. Power sources 180A-180N may be similar to power source 180 of FIG. 1B, and multi-function connections 105A-105N may be similar to multi-function connection 105 of FIG. 1B. For example, power port 192A may provide power from power distribution unit 104 to power source 180A via multi-function connection 105A, and power port 192N may provide power from power distribution unit 104 to power source 180N via multi-function connection 105N.

The multi-function connections (e.g., 105A-105N) may be adapted to supply power to connected power sources (e.g., of data processing systems) and facilitate communication between the power sources and power distribution unit 104. Transmission of data using the multi-function connections may be unidirectional or bidirectional. In a bidirectional example, power distribution unit 104 may transmit data (e.g., power information for power distribution unit 104, responses to power cap requests for data processing system 102) and power to the power sources, and the power sources may transmit data (e.g., power information for data processing system 102, power cap requests for data processing system 102) to power distribution unit 104. However, in unidirectional examples, power distribution unit 104 may transmit power to the power sources, and either the power sources or power distribution unit 104 may transmit data to the other.

Power distribution unit 104 may obtain power via power connection 191 from power source 190. Power connection 191 may include any type of connection usable for transmitting power from power source 190 to power distribution unit 104. Power source 190 may include one or more components usable to convert utility level power (e.g., power from a utility power grid) to data center level power (e.g., power usable by a data center and/or to power any number of deployments (e.g., deployment 198) and/or data processing systems. For example, power source 190 may include a complicated architecture of one or more connected components (e.g., transformers, switches, power and/or bypass panels, power distribution units, batteries, back-up generators) and may connect to a large-scale source of power.

To manage power distribution from power source 190 to the group of power sources (e.g., 180A-180N), power distribution unit 104 may include power manager 194. Power manager 194 may manage a supply of power from power source 190 to power ports 192 via data channels 193. For example, power manager 194 may use data channels 193 to (i) monitor power consumption via each of power ports 192, (ii) perform load balancing tasks (e.g., across power ports 192), (iii) obtain data from power ports 192 (e.g., power cap requests and/or power information for data processing system 102, transmitted from the power sources), (iv) provide data to power ports 192 (e.g., responses to power cap requests for data processing system 102 and/or power information for power distribution unit 104 (any of power ports 192), for transmission to the power sources), and/or (v) perform other actions relating to power distribution and/or management.

Power manager 194 may manage and/or participate in the exchange of data between a connected group of data processing systems and power distribution unit 104. For example, to obtain and/or transmit data usable for power budgeting (e.g., power information, power cap requests, responses), any of power ports 192 may include special hardware (e.g., filters, modulators, and/or other hardware circuitry, not shown) for encoding the data onto a carrier signal of a corresponding multi-function connection and/or for decoding data obtained via the carrier signal.

Power manager 194 may participate in providing data usable for power budgeting to devices remote to power distribution unit 104. For example, power distribution unit 104 may include network components (not shown) and may be connected to a communication system (e.g., out-of-band communication system 106A of FIG. 1A). Power manager 194 may provide the data to a network component of power distribution unit 104 (e.g., via data channels, not shown) for transmission to a remote management system (not shown).

For the purposes of clarity, the example shown in FIG. 1C includes one power distribution unit 104 powering one group (e.g., one rack) of power sources (e.g., 180A-180N) of deployment 198. However, in practice, it may be appreciated that a power distribution system may include a large number of PDUs similar to power distribution unit 104, each PDU providing power to other groups of power sources of deployment 198 not shown in FIG. 1C.

To further clarify embodiments disclosed herein, interaction diagrams in accordance with an embodiment is shown in FIGS. 2A-2B. The interaction diagrams may illustrate how data may be obtained and used within the system of FIGS. 1A-1C.

In the interaction diagrams, processes performed by and interactions between components of a (distributed) system in accordance with an embodiment are shown. In the diagrams, components of the system are illustrated using a first set of shapes (e.g., 102, 104, etc.), located towards the top of each figure. Lines descend from these shapes. Processes performed by the components of the system are illustrated using a second set of shapes (e.g., 200, 206) superimposed over these lines.

Interactions (e.g., communication, data transmissions, etc.) between the components of the system are illustrated using a third set of shapes (e.g., 202, 204) that extend between the lines. The third set of shapes may include lines terminating in arrows that may indicate one-way interactions (e.g., data transmission from a first component to a second component).

Thick arrows (e.g., multi-function connections 105A-105C, data connection 280) may indicate communication channels over which multi-way interactions are facilitated (e.g., data transmission between two components).

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur when managing power budgeting for a data processing system. Data processing system 102 may belong to a deployment of data processing systems powered by a power distribution system that includes power distribution unit 104. As discussed with respect to FIGS. 1A-1C, data processing system 102 may be obtain power from power distribution unit 104 via multi-function connection 105A.

Management system 108 may be tasked with managing power budgeting for the deployment. To do so, management system 108 may maintain a mapping of the power distribution system. The mapping of the power distribution system may be based on power information for components of the deployment (e.g., components of the data processing systems, components of the power distribution system). For example, the power information may include (i) identifiers for components of the deployment (e.g., data processing system 102, power distribution unit 104), (ii) ratings for the components (e.g., a maximum power output, an efficiency rating, a safety rating, an efficiency certification), (iii) information regarding power consumption by and/or supply to the components over time (e.g., information regarding power states, workload queues), (iv) information regarding power caps for the components (e.g., existing power caps, power cap requests), and/or (iv) other types of information relating to operation and/or powering of the components.

The power information may be provided by data processing system 102 and power distribution unit 104. To provide the power information, data processing system 102 and power distribution unit 104 may exchange power information over multi-function connection 105A during a reporting process, such as reporting process 200. For example, during the reporting process, power distribution unit 104 may (i) obtain power information regarding data processing system 102 from data processing system 102, (ii) obtain (e.g., generate) power information regarding power distribution unit 104, and (iii) provide the power information (e.g., regarding both data processing system 102 and power distribution unit 104) to management system 108 over a data connection such as data connection 280.

The power information may be usable by management system 108 to maintain (e.g., obtain, generate, update) the mapping of the power distribution system. For example, the mapping of the power distribution system may be based on (i) power connections between components of the deployment, (ii) existing power caps for components of the deployment, (iii) workloads performed by data processing systems of the deployment, (iv) priority levels for the data processing systems and/or the workloads, and/or (v) other information.

For example, the mapping of the power distribution system may indicate that data processing system 102 is connected to a specific power port of power distribution unit 104, existing power caps for data processing system 102 and power distribution unit 104, workloads performed by (and/or in queue for performance by) data processing system 102, and/or a priority level associated with data processing system 102 that may be based on priority levels for the workloads assigned to data processing system 102.

In other words, the mapping of the power distribution system may indicate (maximum, current, predicted) magnitudes of power draw at each power connection of the power distribution system (e.g., at the PDU level and at the power port level). For example, the mapping of the power distribution system may indicate magnitudes of power draw over time from a power port of power distribution unit 104 that services data processing system 102. Based on information indicated by the mapping, management system 108 may establish and/or update (e.g., increase, decrease) power caps for components of the deployment in accordance with objectives for power distribution within the deployment.

To facilitate the establishing and/or updating of the power caps by management system 108, data processing system 102 and/or power distribution unit 104 may participate in reporting process 200. Reporting process 200 may be performed periodically over time. For example, reporting process 200 may be performed according to a predetermined schedule, based on occurrences of power budgeting events for data processing system 102, and/or based on requests for power information (e.g., provided to data processing system 102 and/or power distribution unit 104 from any operably connected devices). Reporting process 200 may be performed while power is being distributed via multi-function connection 105A.

For example, during reporting process 200, data processing system 102 may make an identification that a power budgeting event has occurred for data processing system 102. The power budgeting event may be identified based on changes in power consumption requirements for data processing system 102 with respect to changes in power supplied to data processing system 102 over periods of time. The power budgeting event may be identified based on an analysis of (i) an existing power cap for data processing system 102, (ii) a power state for data processing system 102 (e.g., portions of hardware resources of data processing system 102 may be unpowered), (iii) current and/or predicted workloads for data processing system 102, and/or (iv) other indicators of power consumption by data processing system 102 over time. The identification of the power budgeting event may trigger data processing system 102 to obtain (e.g., generate) a power cap request.

The power cap request may include (i) an identifier for (a component of) data processing system 102 and/or power distribution unit 104, (ii) a rating for a power source of data processing system 102, (iii) information regarding power consumption by the power source over time (e.g., a magnitude of power requested), and/or (iv) other information (e.g., an existing power cap, cryptographically verifiable information). In a first example, the power cap request may indicate that a power cap has not yet been established for data processing system 102 (e.g., during onboarding for data processing system 102), and the information regarding power consumption by the power source over time may indicate a requested magnitude of power to establish the power cap.

In a second example, the information regarding power consumption by the power source over time may indicate that an existing power cap for data processing system 102 is insufficient for hardware resources of data processing system 102 to perform its assigned workloads (e.g., timely), and therefore the power cap request may indicate an increase to the existing power cap is required in order to meet a production objective for power distribution within the deployment.

In a third example, the information regarding power consumption by the power source over time may indicate that the existing power cap for data processing system 102 is more than sufficient (e.g., above a threshold) for the hardware resources to perform its assigned workloads, and therefore the power cap request may indicate a decrease to the existing power cap is required in order to meet environmental and/or cost objectives for power distribution within the deployment.

During reporting process 200, data processing system 102 may provide the power cap request (and/or other data, such as power information) to power distribution unit 104 over multi-function connection 105A via (i) transmission via a message, (ii) storing in a storage with subsequent retrieval by power distribution unit 104, (iii) a publish-subscribe system where power distribution unit 104 subscribes to updates from data processing system 102 thereby causing a copy of the power cap request to be propagated to power distribution unit 104, and/or (iv) other processes. By providing the power cap request to power distribution unit 104, power distribution unit 104 may facilitate power budgeting services.

To facilitate the power budgeting services, power distribution unit 104 may obtain (e.g., generate) a request. For example, the request may be a data package including (i) the power cap request for data processing system 102, (ii) power information for data processing system 102, (iii) power information for power distribution unit 104, and/or (iv) other information (e.g., metadata, cryptographically verifiable information).

At interaction 202, power distribution unit 104 may provide the request to management system 108 over data connection 280 (e.g., a network connection) via (i) transmission via a message, (ii) storing in a storage with subsequent retrieval by management system 108, (iii) a publish-subscribe system where management system 108 subscribes to updates from power distribution unit 104 thereby causing a copy of the request to be propagated to management system 108, and/or (iv) other processes. For example, power distribution unit 104 may provide the request to management system 108 using an out-of-band communication system (e.g., 106A). By providing the request to management system 108, management system 108 may manage power budgeting for data processing system 102.

To manage power budgeting for data processing system 102 (and other data processing systems of the deployment), management system 108 may perform power budgeting processes (not shown) in order to determine power distribution allowances to the deployment over time. For example, the power budgeting processes may include an analysis of information indicated by the mapping of the power distribution system and/or objectives for power distribution within the deployment. The objectives may include cost objectives, environmental objectives, production objectives, and/or other types of objectives. The power budgeting processes may be performed to obtain a response to the power cap request for data processing system 102.

For example, the response (e.g., the power cap) may be obtained based on an analysis of (i) information indicated by the mapping of the power distribution system (e.g., power connections and/or other types of dependencies between components of the deployment, existing power caps for the components, priority levels for the components and/or workloads assigned to the components), (ii) information included in the power cap request for data processing system 102 (and/or other power cap requests for other components of the deployment), (iii) predictions regarding power consumption by data processing system 102 (in view of power consumption by other data processing systems of the deployment) over time, (iv) predictions regarding power availability to power distribution unit 104 (in view of power availability to other PDUs of the deployment) over time, (v) information regarding the objective for power distribution, and/or (vi) other information regarding the power distribution system. Depending on a result of the analysis, the response may include a (new) power cap for data processing system 102 and/or other information (e.g., executable instructions, policies, cryptographically verifiable information).

At interaction 204, management system 108 may provide the response to power distribution unit 104 over data connection 280 via (i) transmission via a message, (ii) storing in a storage with subsequent retrieval by power distribution unit 104, (iii) a publish-subscribe system where power distribution unit 104 subscribes to updates from management system 108 thereby causing a copy of the response to be propagated to power distribution unit 104, and/or (iv) other processes. By providing the response to power distribution unit 104, power distribution unit 104 may perform a process to update its power mode to provide power to data processing system 102 in a manner that is consistent with the response.

To manage power distribution to data processing system 102, power distribution unit 104 may initiate power mode update process 206. During power mode update process 206, power distribution unit 104 may enforce a power mode based on information included in the response. For example, the response may indicate (i) a power cap for power distribution unit 104 has been modified (e.g., specifying a new maximum magnitude of power that may be drawn by power distribution unit 104 from other components of the power distribution system), and/or (ii) a power cap for data processing system 102 has been modified (e.g., specifying a new maximum magnitude of power that may be provided to data processing system 102).

Power distribution unit 104 may perform actions to limit its power consumption and/or supply based on the maximum magnitude(s) of power specified by the response. For example, power distribution unit 104 may increase or decrease an existing maximum magnitude of power distributed via a power port that services (e.g., powers) data processing system 102 in accordance with the power cap for data processing system 102.

The power cap may include a temporal component. For example, the power cap may include multiple maximum magnitudes of power that are to be enforced on data processing system 102 at various periods in time (e.g., power ramping instructions), and/or the power cap may be enforced at a specified point in time (e.g., at a future point in time). When placed in the new power mode, power distribution unit 104 may permit transmission of a magnitude of power (e.g., that does not exceed the maximum magnitude of power specified by the power cap) via the power port that services data processing system 102 over multi-function connection 105A. During power mode update process 206, power distribution unit 104 may provide at least a portion of the response to data processing system 102.

At interaction 208, power distribution unit 104 may provide the response to data processing system 102 over multi-function connection 105A via (i) transmission via a message, (ii) storing in a storage with subsequent retrieval by data processing system 102, (iii) a publish-subscribe system where data processing system 102 subscribes to updates power distribution unit 104 thereby causing a copy of the response to be propagated to data processing system 102, and/or (iv) other processes. By providing the response to data processing system 102, data processing system 102 may perform a process to update its power state based on information included in the response (e.g., the power cap).

To update its power state, data processing system 102 may identify a new power state indicated by the response. For example, the new power state may include a power state that supplies the hardware resources of data processing system 102 with magnitudes of power over time that do not exceed the maximum magnitude of power specified by the power cap.

Data processing system 102 may perform power state enforcement process 210 to enforce the power state on at least the hardware resources of data processing system 102. During power state enforcement process 210, instructions for enforcing the power state may be obtained and/or executed. For example, a component of data processing system 102 (e.g., a power manager) may obtain (e.g., generate), execute, and/or provide instructions to other components of data processing system 102 (e.g., the hardware resources, a management controller).

The instructions may include instructions for (i) powering or depowering components of the hardware resources (e.g., a graphics processing unit), (ii) powering and/or depowering portions of components of the hardware resources (e.g., a single core of a multi-core processor), (iii) adjusting configuration parameters for portions of hardware resources 150 (e.g., modifying clock speeds), (iv) suspending performance of workloads (e.g., for a period of time), and/or (v) otherwise modifying power consumption by data processing system 102.

During power state enforcement process 210, data may be exchanged between power distribution unit 104 and data processing system 102 (not shown). For example, data processing system 102 may provide a notification to power distribution unit 104 indicating that operation of data processing system 102 has been updated successfully to reflect the power cap. Power distribution unit 104 may delay performance of any portion of power mode update process 206 until the notification is received (e.g., power distribution unit 104 may not update its power mode until power state enforcement process 210 is complete).

Although not shown in FIG. 2A, power distribution unit 104 may provide power to other connected data processing systems via other power ports and other distinct multi-function connections. The other power ports of power distribution unit 104 may be operating in different power modes that reflect power caps of the other connected data processing systems. An example of managing power budgeting for multiple data processing systems is discussed in FIG. 2B.

Turning to FIG. 2B, a second interaction diagram in accordance with an embodiment is shown. The second interaction diagram may illustrate processes and interactions that may occur when managing power budgeting for a deployment. For example, deployment 198 may include power source 180A of a first data processing system, power source 180B of a second data processing system, power source 180C of a third data processing system, and/or power sources of other data processing systems (not shown).

The first, second, and/or third data processing systems may be similar to data processing system 102, and may obtain power from power distribution unit 104 via a distinct multi-function connections. For example, power source 180A may obtain power from a first power port of power distribution unit 104 via multi-function connection 105A, power source 180B may obtain power from a second power port of power distribution unit 104 via multi-function connection 105B, and power source 180C may obtain power from a third power port of power distribution unit 104 via multi-function connection 105C.

As discussed with respect to FIG. 2A, management system 108 may be tasked with managing power budgeting for deployment 198, and may maintain a mapping of a power distribution system that distributes power within deployment 198. The mapping of the power distribution system may be obtained and/or updated based on (real-time) power information obtained from deployment 198. To provide the power information to management system 108, any of power source 180A, power source 180B, power source 180C, and/or power distribution unit 104 may participate in reporting processes 250.

Reporting processes 250 may include reporting processes similar to reporting process 200 of FIG. 2A. For example, reporting processes 250 may include a first reporting process where power source 180A and power distribution unit 104 exchange power information via multi-function connection 105A, a second reporting process where power source 180B and power distribution unit 104 exchange power information via multi-function connection 105B, and/or a third reporting process where power source 180C and power distribution unit 104 exchange power information via multi-function connection 105C. In other words, power source 180A, power source 180B, and/or power source 180C may independently report power information and/or provide power cap requests to power distribution unit 104 at different points in time.

Consider an example where each of power sources 180A-180C have existing power caps of 1000 Watts. The first data processing system (e.g., powered via power source 180A) may identify an occurrence of a power budgeting event for the first data processing system, for example, based on a workload queue, a notification, etc. The power budgeting event may indicate that power source 180A requires 1500 Watts for a period of time in order to provide desired computer-implemented services (e.g., to complete a portion of the queued workloads timely). The first data processing system may generate a power cap request regarding the expected increase in power requirements for the first data processing system.

During one of reporting processes 250, power source 180A may provide the power cap request to power distribution unit 104 over multi-function connection 105A, via methods similar to those described with respect to reporting process 200 of FIG. 2A. At interaction 252, power distribution unit 104 may provide a request (e.g., the power cap request for power source 180A and/or other information, such as real-time power information for any of power sources 180A-180C) to management system 108 over data connection 280 via methods similar to those described with respect to interaction 202 of FIG. 2A.

Upon obtaining the request, management system 108 may perform any number and/or type of power budgeting processes to obtain a response to the request. For example, based on identification information for power source 180A included in the request, management system 108 may use the mapping of the power distribution system to identify that power distribution unit 104 provides power to power source 180A, power source 180B, and power source 180C, each currently capped at 1000 Watts. The mapping of the power distribution system may also indicate that power distribution unit 104 is capped at 3000 Watts. For example, the power cap for power distribution unit 104 may be based on power caps of other PDUs of the power distribution system due to limited availability of power resources and/or in order to meet a cost objective for power distribution within deployment 198.

Management system 108 may obtain a response to the request based on the mapping of the power distribution system and/or power distribution objectives (e.g., the cost objective). The response may include (new) power caps for components of deployment 198. For example, management system 108 may determine that to continue to meet the cost objective and/or other objectives for power distribution, the power cap for power distribution unit 104 should remain at 3000 Watts. Management system 108 may obtain and/or analyze other information such as priority levels for each of power sources 180A-180C (and/or their respective workloads) to determine new power caps for power sources 180A-180C.

In the example shown in FIG. 2B, power source 180A may be a high priority power source, and power sources 180B-180C may be medium priority power sources. Based on the priority levels for each of power sources 180A-180C, management system 108 may grant a new (e.g., increased) power cap of 1500 Watts to power source 180A, accommodated by new (e.g., decreased) power caps of 750 Watts for each of power source 180B and power source 180C.

In other examples, depending on priority levels and/or objectives for power distribution, management system 108 may (i) update (e.g., increase) the power cap for power distribution unit 104 in order to accommodate the new (e.g., increased) power cap for power source 180A without modifying the existing power caps for power source 180B and power source 180C, or (ii) deny the power cap request for power source 180A (e.g., provide a response indicating that power source 180A is to remain capped at 1000 Watts).

In an example where the power cap request for power source 180A is denied, management system 108 may perform additional actions to meet objectives for power distribution (e.g., production objectives). For example, management system 108 may perform actions to (i) reassign workloads to other data processing systems powered by other PDUs of the deployment, and/or (ii) pause low priority workloads assigned to the first data processing system for a period of time so that power resources may be allocated to high priority workloads.

At interaction 254, management system 108 may provide the response (e.g., the new power caps for power sources 180A-180C and/or other information) to power distribution unit 104 over data connection 280, via methods similar to those described with respect to interaction 204 of FIG. 2A. Upon obtaining the response from management system 108, power distribution unit 104 may initiate power mode update process 256.

Power mode update process 256 may be similar to power mode update process 206 of FIG. 2A. During power mode update process 256, power distribution unit 104 may use the response to identify power modes to be enforced on power distribution unit 104 and/or its power ports in accordance with information included in the response. For example, power distribution unit 104 may modify (e.g., increase, decrease) maximum magnitudes of power distributed via the first, second, and/or third power ports over time, as specified by the new power caps. Once the power modes are enforced, the first power port may provide a maximum of 1500 Watts to power source 180A, and the second and third power ports may provide a maximum of 750 Watts to each of power sources 180B and 180C, respectively.

At interactions 258A, 258B, and/or 258C, power distribution unit 104 may provide portions of the response to power sources 180A-180C over their respective multi-function connections, via methods similar to those described with respect to interaction 208 of FIG. 2A. By doing so, any of power sources 180A-180C may use the portions of the response to independently initiate performance of power state enforcement processes similar to power state enforcement process 210 of FIG. 2A. For example, the first, second, and/or third data processing systems may update operation of the hardware resources so that power consumption requirements do not exceed the new power caps.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIGS. 2A-2B, power budgeting for a deployment of data processing systems may be managed by using power-based communications to obtain information used in determining power caps (e.g., power budgets) for components of the deployment. By doing so, the power caps may be managed dynamically and timely (e.g., in near real-time) without relying on manual efforts and/or on additional connections (e.g., network connections) between the components of the deployment.

Turning to FIG. 3, a flow diagram illustrating a method in accordance with an embodiment is shown. The flow diagram may illustrate various operations performed when managing a data processing system.

The data processing system may belong to a deployment of data processing systems. A PDU may supply power to at least the data processing system using a multi-function connection (e.g., the PDU may also supply power to other data processing systems of the deployment via distinct multi-function connections). The multi-function connection may be adapted to both supply power to the data processing system and facilitate communication between the data processing system and the PDU.

At operation 300, an identification of an occurrence of a power budgeting event for the data processing system may be made. The identification may be made by (i) analyzing information regarding power supplied by the PDU and/or consumed by the data processing system (e.g., over time) with respect to policies for the data processing system, (ii) obtaining notifications from other entities (e.g., the PDU, a management system, another component of the data processing system) indicating occurrence of the event, and/or (iii) other methods.

In a first example of making the identification, a power manager of the data processing system may make the identification by (i) analyzing workload information (e.g., process queues) of the data processing system to identify workload types (e.g., heavy workloads, light workloads) and/or quantities of power consumption associated with the workload types over time, (ii) analyzing power information obtained from the PDU to identify quantities of power available to the data processing system over time (e.g., the quantities of power available to the data processing system may be limited by the existing power cap), and/or (iii) comparing the quantities of power consumption and the quantities of power available (over time) with respect to thresholds defined by the policies in order to identify periods of time associated with power budgeting events.

In a second example of making the identification, a user or administrator of the data processing system may report the occurrence of the power budgeting event to a management system, and/or the management system may identify the occurrence of the power budgeting event (e.g., based on power information provided by the PDU). The data processing system may obtain the notification from the management system via out-of-band communication channels and/or in-band communication channels of the data processing system. The data processing system may obtain the notification from the management system via the PDU and using power-based communications (e.g., using the multi-function connection).

At operation 302, based on the identification, a power cap request for the data processing system may be provided to the PDU using the multi-function connection. The power cap request may be provided by methods described with respect to interaction 202 of FIG. 2A, and/or by other methods.

For example, the power budgeting event may trigger the data processing system to obtain (e.g., generate) the power cap request. While power is being distributed via the multi-function connection, a data package including the power cap request may be encoded onto a carrier signal distributed via the multi-function connection. For example, the data package may be encoded onto the carrier signal by a power source of the data processing system, using an encoding technique that modulates the carrier signal to reflect information in the data package.

At operation 304, a response to the power cap request may be obtained from the PDU via the multi-function connection. The response may be obtained by methods described with respect to interaction 208 of FIG. 2A and/or by other methods. For example, while power is being distributed via the multi-function connection, a modulated carrier signal (e.g., modulated to reflect a data package including the response) transmitted by the PDU may be decoded (e.g., by the power source) to obtain the response. The response may indicate a new power state for the data processing and/or may include instructions for enforcing the new power state.

At operation 306, the new power state may be enforced on at least hardware resources of the data processing system to obtain an updated data processing system. The new power state may be enforced by (i) identifying the new power state (e.g., based on a maximum magnitude of power allocated to the data processing system for consumption as specified by the response), (ii) obtaining (e.g., generating) instructions for enforcing the new power state, (iii) inserting a first portion of the instructions into an execution flow for a component of the data processing system (e.g., a processor of the data processing system), (iv) providing a second portion of the instructions to a remote system for execution, and/or (v) by other methods.

For example, once a portion of the instructions is performed, operation of hardware resources of the data processing system may be updated (e.g., via depowering and/or powering portions of components of the hardware resources), thereby updating (operation of) the data processing system. For more details regarding the instructions, refer to power state enforcement process 210 of FIG. 2A.

At operation 308, computer-implemented services may be provided using the updated data processing system. The computer-implemented service may be provided by (i) obtaining instructions (e.g., user input, instructions from another device, instructions generated by software components of the hardware resources), (ii) inserting the instructions into an execution flow for a powered portion of the hardware resources, and/or (iii) executing the instructions using powered hardware resources of the updated processing system.

The method may end following operation 308.

Thus, as illustrated above, embodiments disclosed herein may provide systems and methods for managing data processing systems using power-based communications. Information used in power budgeting, such as power cap requests and power information, may be provided to a management system automatically via existing multi-function connections that power the data processing systems. By doing so, the information used in power budgeting may be more likely to be reliable, and manual efforts and/or additional connectivity within the deployment may not be necessary to meet objectives for power distribution within the deployment.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a data processing system, the method comprising:
making an identification, by the data processing system, of an occurrence of a power budgeting event for the data processing system; and
based on the identification:
providing, by the data processing system and using a multi-function connection, a power cap request for the data processing system to a power distribution unit (PDU) that supplies power to at least the data processing system, and the multi-function connection being adapted to both supply power to the data processing system and facilitate communication between the data processing system and the PDU,
obtaining, by the data processing system, a response to the power cap request via the multi-function connection and from the PDU, the response being based on a mapping of a power distribution system maintained by a management system, the mapping being based on power information provided by the data processing system and the PDU using the multi-function connection, and the response indicating a new power state for the data processing system,
enforcing, by the data processing system, the new power state on at least hardware resources of the data processing system to obtain an updated data processing system, and
providing, using the updated data processing system, computer-implemented services.

2. The method of claim 1, wherein the power cap request comprises at least one selected from a group consisting of:
an identifier for the data processing system;
a rating for a power source of the data processing system; and
information regarding power consumption by the power source over time.

3. The method of claim 1, wherein the management system is tasked with managing power budgeting for a deployment of data processing systems that comprises the data processing system.

4. The method of claim 3, wherein the mapping of the power distribution system is based on at least one selected from a group consisting of:
power connections between components of the deployment;
existing power caps for the components of the deployment;
workloads performed by the data processing systems; and
priority levels for the data processing systems and/or the workloads.

5. The method of claim 3, wherein the response is based, at least in part, on the mapping of the power distribution system, and an objective for power distribution within the deployment.

6. The method of claim 5, wherein the response is also based, at least in part, on a power cap for the PDU.

7. The method of claim 6, wherein the power cap for the PDU is based, at least in part, on power caps for other PDUs of the deployment.

8. The method of claim 5, wherein the response comprises a power cap for the data processing system based, at least in part, on a priority level for the data processing system.

9. The method of claim 8, wherein enforcing the new power state modifies power consumption by the data processing system in accordance with the priority level.

10. The method of claim 1, wherein the providing and obtaining are performed while power is being distributed via the multi-function connection.

11. The method of claim 1, wherein the PDU is connected to at least two data processing systems via distinct multi-function connections.

12. The method of claim 1, wherein the PDU is adapted to obtain data center level power and supply power source level power via distinct multi-function connections.

13. The method of claim 1, wherein the data processing system is connected to the PDU via an out-of-band communication channel that runs through a network module of the data processing system, and the out-of-band communication channel services a management controller of the data processing system.

14. The method of claim 13, wherein the data processing system is connected to at least one other entity via an in-band communication channel that also runs through the network module, and the in-band communication channel services the hardware resources.

15. A non-transitory machine-readable medium having instructions stored therein, which when executed by a processor, cause the processor to perform operations for managing a data processing system, the operations comprising:
making an identification, by the data processing system, of an occurrence of a power budgeting event for the data processing system; and
based on the identification:
providing, by the data processing system and using a multi-function connection, a power cap request for the data processing system to a power distribution unit (PDU) that supplies power to at least the data processing system, and the multi-function connection being adapted to both supply power to the data processing system and facilitate communication between the data processing system and the PDU,
obtaining, by the data processing system, a response to the power cap request via the multi-function connection and from the PDU, the response being based on a mapping of a power distribution system maintained by a management system, the mapping being based on power information provided by the data processing system and the PDU using the multi-function connection, and the response indicating a new power state for the data processing system,
enforcing, by the data processing system, the new power state on at least hardware resources of the data processing system to obtain an updated data processing system, and
providing, using the updated data processing system, computer-implemented services.

16. The non-transitory machine-readable medium of claim 15, wherein the power cap request comprises at least one selected from a group consisting of:
an identifier for the data processing system;
a rating for a power source of the data processing system; and
information regarding power consumption by the power source over time.

17. The non-transitory machine-readable medium of claim 15, wherein the management system is tasked with managing power budgeting for a deployment of data processing systems that comprises the data processing system.

18. A data processing system, comprising:
a processor; and
a memory coupled to the processor to store instructions, which when executed by the processor, cause operations for managing the data processing system to be performed, the operations comprising:
making an identification, by the data processing system, of an occurrence of a power budgeting event for the data processing system, and
based on the identification:
providing, by the data processing system and using a multi-function connection, a power cap request for the data processing system to a power distribution unit (PDU) that supplies power to at least the data processing system, and the multi-function connection being adapted to both supply power to the data processing system and facilitate communication between the data processing system and the PDU;
obtaining, by the data processing system, a response to the power cap request via the multi-function connection and from the PDU, the response being based on a mapping of a power distribution system maintained by a management system, the mapping being based on power information provided by the data processing system and the PDU using the multi-function connection, and the response indicating a new power state for the data processing system;
enforcing, by the data processing system, the new power state on at least hardware resources of the data processing system to obtain an updated data processing system; and
providing, using the updated data processing system, computer-implemented services.

19. The data processing system of claim 18, wherein the power cap request comprises at least one selected from a group consisting of:
an identifier for the data processing system;
a rating for a power source of the data processing system; and
information regarding power consumption by the power source over time.

20. The data processing system of claim 18, wherein the management system is tasked with managing power budgeting for a deployment of data processing systems that comprises the data processing system.
